(19) United States
(12) Patent Application Publication
(10) Pub. No.: US 2005/0050226 A1
(43) Pub. Date: Mar. 3, 2005

(54) Device mapping based on authentication user name

(76) Inventor: Nils Larson, Austin, TX (US)

Correspondence Address: DLA PIPER RUDNICK GRAY CARY USA, LLP, 2000 University Avenue, E. Palo Alto, CA, 94303-2248, US

(21) Appl. No.: 10/649,422

(22) Filed: Aug. 26, 2003

(51) Int. Cl. G06F 15/16

(52) U.S. Cl. 709/245

(57) ABSTRACT

Systems and methods for controlling access by users that are not uniquely identified on a network to one or more devices that are coupled to the network through a device such as a router. In one embodiment, a router that couples one or more storage devices such as tape drives to an IP network maintains one or more tables to control access by devices on the IP network to the storage devices. Each table lists a set of the storage devices. One or more of the devices connected to the IP network are associated with each of the tables and are authorized to access the storage devices identified in the corresponding table. The IP devices are uniquely identified and associated with the tables using corresponding usernames and passwords with which the devices log onto the IP network.

### BACKGROUND OF THE INVENTION

1. Field of the Invention

The invention relates generally to network communications and more particularly to systems and methods for controlling access by users that are not uniquely identified on a network to one or more devices that are coupled to the network through a device such as a router.

2. Related Art

Increasingly, computer systems are interconnected with other computer systems, storage devices, peripherals, and the like, rather than simply being configured as stand-alone systems. Typically, these devices are interconnected through various types of networks. Often, computer systems are connected to persistent storage devices or backup systems through networks.

Storage devices which are connected directly to a network medium and can be used by other devices on the network to store data may be referred to as network attached storage. Network attached storage devices are typically assigned IP addresses so that they can be accessed by the other (client) devices providing data storage via a network attached storage device can provide various advantages, such as the ability to centralize data storage, the ability to store data from many different platforms, the ability to expand the available storage space, and so on.

A storage area network (SAN) is a network of storage devices. A SAN may provide convenient access to large amounts of storage space that are not effectively implemented as local storage for a single computer system. SANs are commonly implemented using protocols such as SCSI or Fibre Channel. A SAN typically includes a server that acts as an access point to the SAN. SANs may provide various advantages over other types of network attached storage because the devices on the SAN may be able to communicate without having to use the primary network (the network on which the devices that utilize the storage devices on the SAN reside). Because the SAN data traffic is separated from the primary network's traffic, the performance of the primary network may be enhanced.

It may be desirable in a SAN to implement some sort of control over data communications between the various devices. For example, if there are a number of host devices that store data on the SAN's storage devices, it may be desirable to manage the way the hosts access the storage devices in order to maintain the efficient functioning of the SAN or to protect the integrity of each host's data on the storage devices. One typical management function is the simple control of access to particular storage devices. In other words, particular host devices may only be allowed to access certain ones of the storage devices. Data storage for each host devices may therefore be mapped to corresponding ones of the storage devices to which access is allowed.

In a Fibre Channel network, host devices can be easily mapped to corresponding storage devices because the host devices have corresponding persistent identifiers. Specifically, each device on a Fibre Channel network has a worldwide name associated with it. This worldwide name is a part of the Fibre Channel protocol. The worldwide name is persistent and can be used to identify the corresponding device in communications over the network. There are, however, other types of networks in which the devices are not so easily identified. For example, network data management protocol (NDMP) networks do not have an equivalent to the Fibre Channel worldwide name.

NDMP was designed to allow data transfer operations over IP networks. In particular, NDMP is used for backing up heterogeneous file servers to tape drives over IP networks. Because NDMP was designed for use in IP networks, it makes use of IP addresses. IP addresses, however, may change. A host device's IP address therefore cannot be used as a means for persistent identification of that device. Consequently, mapping of devices (e.g., for control of access to storage devices) cannot be based upon the devices' IP addresses. Another mechanism must therefore be provided for identifying the devices for the purpose of access control.

### SUMMARY OF THE INVENTION

One or more of the problems outlined above may be solved by the various embodiments of the invention. Broadly speaking, the invention comprises systems and methods for controlling access by users that are not uniquely identified on a network to one or more devices that are coupled to the network through a device such as a router. In one embodiment, a router that couples one or more storage devices such as tape drives to an IP network maintains one or more tables to control access by devices on the IP network to the storage devices. Each table lists a set of the storage devices. One or more of the devices connected to the IP network are associated with each of the tables and are authorized to access the storage devices identified in the corresponding table. The IP devices are uniquely identified and associated with the tables using corresponding usernames and passwords with which the devices log onto the IP network.

One embodiment of the invention comprises a system having an interface to an IP network, an interface to one or more target devices, a processor coupled to the interfaces, and a memory. The processor is configured to maintain in the memory a mapping of users that are connected to the IP network to the one or more target devices, to identify users according to corresponding login information, and to enable access from the users to the one or more target devices according to the mapping. In one embodiment, the system comprises a router configured to be coupled between an IP network and a SCSI bus, wherein the router is configured to maintain one or more access control tables. Each table identifies one or more tape servers connected to the SCSI bus. Each user connected to the IP network may be associated with one of the tables. A management application coupled to the router is configured to identify each user by corresponding usernames and passwords and to communicate this information to the router to determine from the table associated with the user (if any). The tape servers listed in the associated table are communicated to the management application, which then directs the user to access one or more of the identified tape servers.

Another embodiment of the invention comprises a method including the steps of maintaining a mapping of users that are connected to an IP network to one or more target devices, identifying users according to corresponding login information, and enabling access from the users to the one or more target devices according to the mapping and login information. In one embodiment, the mapping is maintained in a router that is located between the IP network and a transport medium to which the target devices are connected. The mapping comprises one or more tables, each identifying a set of target devices and a set of users that are authorized to access the identified set of target devices. The login information for each user comprises a username and corresponding password. Access by a user to the target devices is enabled by providing the login information to a management application, which then communicates this information to the router to determine, based upon the corresponding table, which of the target devices can be accessed by the user. This information is returned to the management application, which then instructs the user to access one or more of the identified target devices.

Another embodiment of the invention may comprise a software product. The software product consists of software code that is configured to enable a data processor within a device such as a router or workstation to perform a method as described herein. The software code may comprise lines of compiled C⁺⁺, Java, or any other suitable programming language. The software code may reside within ROM, RAM, hard disk drives or other computer-readable media within the system. The software code may also be contained on a separable data storage device, such as a removable hard disk, or on removable computer-readable media such as a DASD array, magnetic tape, floppy diskette, optical storage device, or the like.

Numerous additional embodiments are also possible.

The various embodiments of the invention may provide a number of advantages over prior art systems and methods. For example, systems that use NDMP over an IP network to perform backup operations do not provide unique worldwide names for devices on the network. Instead, the devices have IP addresses that can change from time to time. As a result, no unique identification of the devices is provided to support access controls from the devices to storage devices on the network. Embodiments of the present invention utilize login information such as usernames and corresponding passwords to uniquely identify the devices, thereby enabling identification of the devices for the purpose of controlling access to storage devices. Embodiments of the present invention also provide a unique mechanism for controlling access by maintaining tables with which the devices are associated, wherein each device can access the storage devices identified in the associated table. Various other advantages may also be provided.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary network.

FIG. 2 is a diagram illustrating the communications between a file server system, backup device and data management device in accordance with one embodiment.

FIG. 3 is a diagram illustrating an exemplary network system in which one embodiment of the invention is implemented.

FIG. 4 is a flow diagram illustrating a method in accordance with one embodiment.

FIG. 5 is a diagram illustrating an exemplary network in accordance with an alternative embodiment.

FIG. 6 is a diagram illustrating the structure of a router in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF PREFERRED EMBODIMENTS

One or more preferred embodiments of the invention are described below. It should be noted that these and any other embodiments described below are exemplary and are intended to be illustrative of the invention rather than limiting.

Broadly speaking, the invention comprises systems and methods for controlling access by users that are not uniquely identified on a network to one or more devices that are coupled to the network through a device such as a router.

One embodiment comprises a system for backing up file servers to tape drives in an NDMP environment. In this embodiment, one or more users (e.g., file servers) are connected to an IP network. One or more tape drives or other storage devices are also connected to the IP network through a router, which is directly connected to the network. In this embodiment, the file servers and the router are configured to communicate with each other using NDMP, while the tape drives are configured to communicate with the router via a SCSI bus using SCSI commands.

In this embodiment, the router is configured to maintain one or more tables that map users to sets of the tape drives. These tables are used to control the users' access to the tape drives. Each user is uniquely identified, and this identification is used to associate the user with one of the tables, thereby allowing the user to access the tape drives listed in the table. Because NDMP does not create unique names for the devices that are on the IP network (and because the IP addresses of the devices on the network may change), a mechanism is provided for assigning unique names to the users. In this embodiment, the unique names comprise usernames and corresponding passwords with which the users log onto the network.

Thus, when a system administrator sets up the network or later updates the network configuration, the tables in the router are defined. When a user logs in to the IP network using a particular username and password, the username and password are used to identify the table with which the user is associated. This table lists the tape drives that are accessible by the user. When it is necessary to backup the user device, a management application that controls the backup operations communicates with the router to determine which of the tape drives, if any, the user is allowed to access. The management application then instructs the user device to backup its data to one of the tape drives identified as being accessible by the user device.

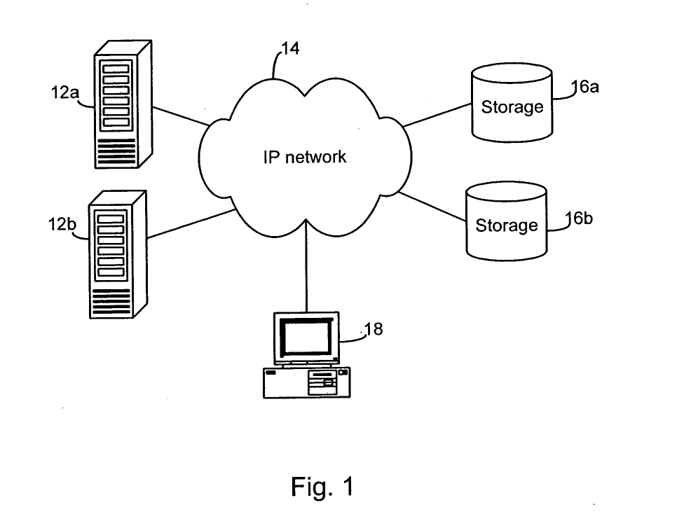

Referring to FIG. 1, a diagram illustrating a network is shown. In this embodiment, a number of file server systems 12 are connected to IP network 14. A number of backup devices 16 are also connected to network 14. Additional users 18 may also be connected to network 14. In one embodiment, user 18 may be configured to run a data management application which controls the backup of data from one or more of file server systems 12 to one or more of backup devices 16.

It should be noted that, for the purposes of this disclosure, identical items in the figures may be indicated by identical reference numerals followed by a lowercase letter, e.g., 12a, 12b, and so on. The items may be collectively referred to herein simply by the reference numeral.

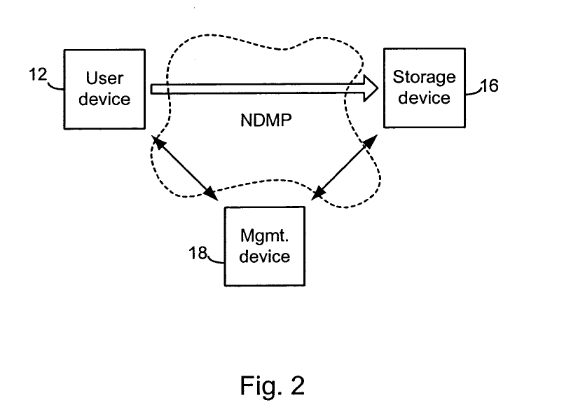

Referring to FIG. 2, a diagram illustrating the communications between a file server system 12, backup device 16 and data management device 18 relating to the backup of data from file server system 12 to backup device 16 is shown. As depicted in this figure, data management device 18 communicates with both file server system 12 and backup device 16. These communications use NDMP and serve to control the backup of data from file server system 12 to backup device 16. FIG. 2 also depicts the transfer of data (using NDMP) from file server system 12 to backup device 16.

The use of NDMP in the backup operations is intended to solve a number of problems that existed with prior art methods for backing up data to network attached storage devices. In the prior art, backup applications were specifically designed for many different platforms and operating systems, and might be present in several different versions (releases). The various devices that might be attached to a network might each use different backup applications, so that the backup of each device could not be easily coordinated with the others.

NDMP is an open standard protocol for IP-network-based backups to network attached storage devices. NDMP provides a single, well-defined protocol to be used by backup applications. The backup applications which follow this protocol can operate in a coordinated manner, even though the applications and/or the devices to be backed up are heterogeneous.

One of the problems with NDMP-based backup systems, however, is that implementing access controls for backups may be more difficult than in other types of systems. Consider, for example, the problem of identifying a particular device and the corresponding permissions to backup data to certain storage devices. In a Fibre Channel-based system, a first device (e.g., a file server) which is to be backed up has a unique worldwide name. Access controls can be implemented by associating this unique worldwide name with a storage device (or set of storage devices) to which the first device may backup its data. In an NDMP system, however, the network is an IP network. In an IP network, devices are identified by their corresponding IP addresses. These IP addresses may change from time to time, so they cannot be used as identifiers for the purpose of implementing access controls. Similarly, it is not always possible to use the physical (MAC) address of the devices for the purpose of uniquely identifying them. Some alternative mechanism for uniquely identifying the devices to be backed up is therefore necessary.

In one embodiment, the mechanism provided for this purpose comprises requiring devices to log in to the network, and using the respective devices' usernames and passwords as unique identifiers through which the devices can be associated with one or more of the storage devices which they are allowed to access.

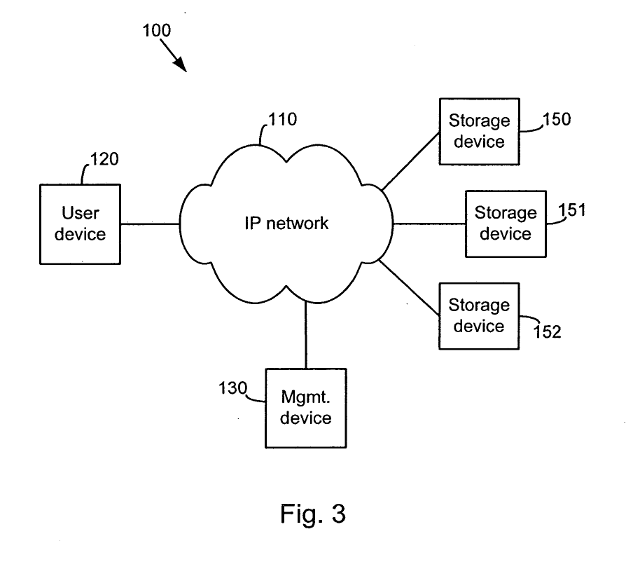

Referring to FIG. 3, a diagram illustrating an exemplary network system in which one embodiment of the invention is implemented is shown. As depicted in this figure, system 100 comprises an IP network 110 to which a number of devices are connected. These devices include a first device 120 that needs to be periodically backed up, a management system 130 and several storage devices, 150, 151 and 152. In one embodiment, device 120 may be a device such as a file server. Storage devices 150, 151 and 152 may be tape drives.

In system 100, device 120 is required to log in to the system. As part of the login procedure, the device must provide its username and corresponding password. After the device has logged in to the system, it operates normally. When it is desired to back up the device, the backup operations are controlled by a data management application which may, for example, be resident on management system 130.

For the purposes of this example, it is assumed that it is desired to back up the data on device 120 to one or more of storage devices 150-152. Management system 130 communicates with device 120 and storage devices 150-152 to control the backup operation. In this embodiment, management system 130 provides access controls between device 120 and storage devices 150-152. Thus, when it is desired to back up device 120 to one of storage devices 150-152, management system 130 first determines whether or not device 120 is authorized to access the requested storage device. This determination is made based upon the unique username-password identifier for device 120 and the corresponding table stored in the router. Device 120 may be backed up to one of the storage devices listed in the table. Management system 130 therefore directs device 120 to back up its data to one of the listed storage devices. If no storage devices are listed in the table associated with device 120 (as identified by its username/password), or if none of the tables stored in the router are associated with device 120, management system 130 may generate an error, or handle the needed backup operations in a different manner (e.g., by backing up the data to a storage device connected to a different router).

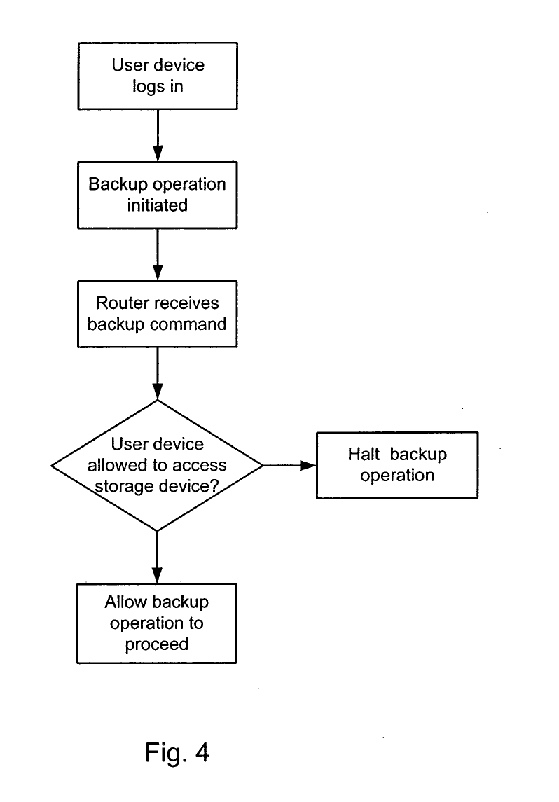

Referring to FIG. 4, a flow diagram illustrating a method in accordance with one embodiment is shown. This method corresponds generally to a backup operation in the system of FIG. 3. During operation of the network, the management system discovers the user device and the router (block 200). This may occur when the network is initially set up, or as the management system, user device and/or router join the network. At some point, the management system determines that the user device needs to be backed up (block 210). The management application therefore logs in to the router using a username/password associated with the user device in order to access the table associated with the user device (block 220). (The management system may have also logged in to the user device with an unrelated username and/or password.) The management system then identifies the storage devices (listed in the table) which are accessible by the user device (block 230) and directs the user device to back up its data to one of the storage devices identified in the table associated with the user device (block 240). The user device then backs up its data to the storage device as directed by the management application (block 250).

The management system may poll the user device to determine when the user device has completed the backup operation. The management system may also perform certain operations to “finish” the backup, such as writing a file marker, rewinding, updating a directory associated with the storage device, and so on. The management system would typically also log out from the router/storage device and, if necessary, the user device.

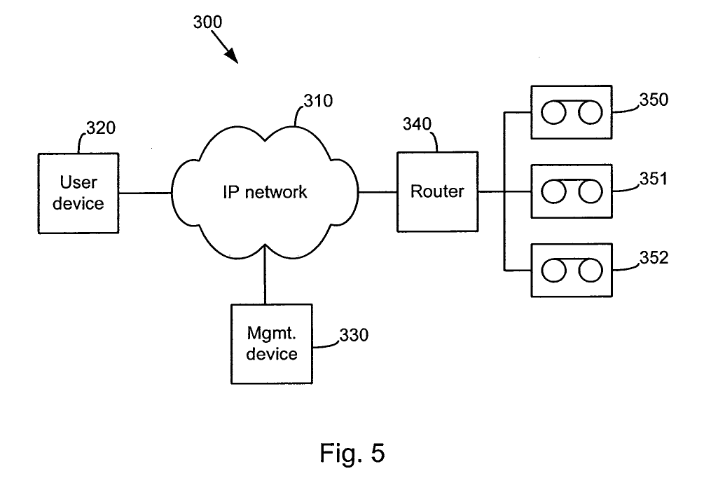

Referring to FIG. 5, a diagram illustrating an exemplary network in accordance with an alternative embodiment is shown. In this embodiment, a system comprises an IP network 300, which has a file server 320, a management system 330 and a router 340 connected to it. Router 340 is also connected to tape drives 350. In this embodiment, tape drives 350-352 are SCSI devices and are connected to router 340 via a SCSI bus.

While only three tape drives are depicted in the figure, there may be other tape drives or other types of storage devices that are connected to network 310 via router 340. References to tape drives 350-352 in the following discussion may include these other devices.

In this example, it is assumed that file server 320 needs to be backed up onto one of tape drives 350-352. Management system 330 has a data management application running on it which is designed to control the backup operation. The data management application is configured to communicate with file server 320 and tape drives 350-352 (via router 340) using NDMP.

In this embodiment, the access controls between file server 320 and tape drives 350-352 are not implemented solely in the management system 330. Instead, they are implemented in part in router 340. This moves some of the responsibility for maintaining access controls from the data management application in system 330 to the router, so that little or no modification of the data management application is necessary. Router 340 is configured to maintain a set of tables that define the accessibility of tape drives 350-352 by file server 320. In this embodiment, each of the tables may list one or more of tape drives 350-352. Each of the tables is associated with one or more devices, such as file server 320. Each device is authorized to access those tape drives (or other storage devices) that are listed in the table that is associated with the device.

When the data management application needs to initiate a backup operation for a user device (e.g., file server 320), it communicates with router 340 to determine which of the storage devices (e.g., tape drive 350) can be accessed by the user device. This comprises identifying the one of the tables stored by the router which is associated with the username and password of the user device, and reading the storage devices listed in the table. The user device is authorized to access the listed storage devices. The data management application then selects one of the storage devices which the user device is allowed to access and directs the user device to backup its data to the selected storage device. The user device then backs up its data to the storage device as directed by the management application. The process by which the management application verifies authorization of the user device to access the storage device is transparent to the user device.

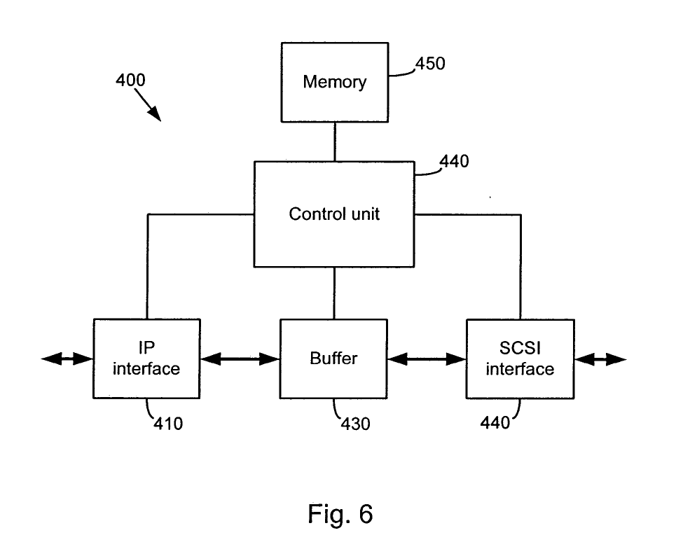

Referring to FIG. 6, a diagram illustrating the structure of a router in accordance with one embodiment is shown. This router may be used in the system of FIG. 5. Router 400 includes an interface 410 to the IP network, an interface 420 to the SCSI bus, a buffer 430, a control unit 440 and a memory 450. Control unit 440 is coupled to interface 410, interface 420, buffer 430 and memory 450, and is configured to control the operation of these components.

Data which is received at IP interface 410 is stored in buffer 430 and, if appropriate, retrieved from buffer 430 to be forwarded by interface 420 to the appropriate storage device. Any necessary reformatting of the data is managed by appropriate interface controllers associated with the interfaces. The decision regarding whether or not to forward the data is determined by control unit 440 based upon tables which are stored in memory 450. As indicated above, each table contains a list of storage devices. The list need not be in any particular format, and in fact need not take the form of a list. The table simply identifies a set of storage devices. A table may identify multiple storage devices, a single storage device, or no devices at all (i.e., a null set).

Each table may be associated with one or more users. (“Users” here refers to the file servers or other devices that may need to be backed up, since they are logged in to the network as users.) Alternatively, a table may not have any users associated with it. The users are associated with the tables in one embodiment by linking the users' respective usernames and passwords with the tables. In other embodiments, identifiers other than the usernames and passwords may be used to associate the users with the tables. For example, usernames or passwords alone may be used as identifiers if they are unique.

Router 400 may be configured in accordance with the foregoing description by installing appropriate software code in the router. The software code is executable by control unit 440 (or another suitable data processor) to operate as described above. It should be noted that the software code itself is an alternative embodiment of the invention. The software code may reside within ROM, RAM, hard disk drives or other computer-readable media within the system. The software code may also be contained on a separable data storage device, such as a removable hard disk, or on removable computer-readable media such as a DASD array, magnetic tape, floppy diskette, optical storage device, or the like. The software code may comprise lines of compiled C⁺⁺, Java, or any other suitable programming language.

In one embodiment, a system administrator is responsible for configuring the system. In other words, the system administrator is required to set up the usernames and/or passwords that will be used to identify the user devices. This may be done manually, or through an automated mechanism of some sort. The system administrator is also required to define the access that each user device will have to each of the storage devices. This is accomplished by setting up the one or more tables which list the sets of storage devices and which are associated with the particular user devices that can access the corresponding storage devices.

The system administrator may access the system via a management station on the network. This management station may, for example, comprise a workstation coupled to the IP network. This workstation may also run the data management application that handles the backup operations. If the tables and the access control functions are resident in a device such as a router, the system administrator may alternatively manage the system via a connection to the router itself. This connection may be an Ethernet connection to an Ethernet port in the router, a serial connection to an RS-232 port, or a telnet session via a telnet port.

While the embodiments of the invention which are described above focus on an implementation in which a router positioned between one or more file servers on an IP network and one or more tape drives on a SCSI bus, the invention is contemplated to be more broadly applicable. For example, some embodiments of the invention may in connection with networks that are not IP-based, but which fail to provide a unique worldwide identifier of user devices and therefore require a username-password identifier or similar mechanism for providing unique identification of these devices. The user devices themselves also need not be limited to file servers, but may comprise any type of device that needs to access the devices to which access is controlled. Similarly, the controlled access devices need not be limited to tape drives, and need not be coupled to a SCSI bus.

It should also be noted that, while the embodiments described above focus on the implementation of the user-device/storage-device tables within a router, other embodiments may implement this same functionality in other components of the system. For instance, a computer on which the data management application runs may also maintain the tables and control the flow of commands relating to the backup of data from the user devices to the storage devices over the network.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms ‘comprises,’ ‘comprising,’ or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A system comprising:
an interface to an IP network;
an interface to one or more target devices;
a processor coupled to the interfaces; and
a memory;
wherein the processor is configured
to maintain in the memory a mapping of users that are connected to the IP network to the one or more target devices,
to access the mapping according to login information corresponding to the users, and
to enable access from the users to the one or more target devices according to the mapping.

2. The system of claim 1,
wherein the system comprises a router configured to be coupled between an IP network and a SCSI bus,
wherein the router is configured
to maintain one or more access control tables, wherein each table identifies one or more tape servers,
to enable access to the access control tables according to the login information corresponding to the users
to associate each user with one of the tables, and
to enable each user to access the one or more tape servers identified in the table associated with the user.

3. The system of claim 1, wherein the mapping comprises one or more tables, wherein each table is associated with one or more users and wherein each of the associated users is mapped to a set of the one or more target devices listed in the table.

4. The system of claim 1, wherein the login information comprises a username associated with the user.

5. The system of claim 1, wherein the login information comprises a username and a corresponding password associated with the user.

6. The system of claim 1, wherein the target devices comprise storage devices.

7. The system of claim 1, wherein the target devices comprise tape drives.

8. The system of claim 1, wherein the target devices comprise SCSI devices.

9. The system of claim 1, wherein communications between the users and the processor comprise NDMP communications.

10. The system of claim 1, wherein the system comprises a router.

11. The system of claim 1, wherein the interface to the one or more target devices comprises an interface to a non-IP network to which the target devices are connected.

12. The system of claim 1, further comprising a management station configured to enable access to the mapping.

13. A method comprising:
maintaining a mapping of users that are connected to an IP network to one or more target devices;
accessing the mapping according to login information corresponding to one or more users; and
enabling access from the one or more users to the one or more target devices according to the mapping.

14. The method of claim 13,
wherein the mapping is maintained in a router that is located between the IP network and a transport medium to which the target devices are connected;
wherein the mapping comprises one or more tables, each identifying a set of target devices and a set of users that are authorized to access the identified set of target devices;
wherein the login information for each user comprises a username and corresponding password; and
wherein enabling access from each user comprises examining one of the tables that is associated with the user, determining whether one of the set of target devices is identified in the table associated with the user, and directing the user to access the one of the set of target devices.

15. The method of claim 13, further comprising interfacing with the IP network.

16. The method of claim 13, further comprising communicating with the users via NDMP communications.

17. The method of claim 13, wherein accessing the mapping according to login information corresponding to one or more users comprises associating a username with each user.

18. The method of claim 13, wherein accessing the mapping according to login information corresponding to one or more users comprises associating a username and password with each user.

19. The method of claim 13, wherein maintaining the mapping comprises maintaining one or more tables, wherein each table is associated with one or more users and wherein each of the associated users is mapped to a set of the one or more target devices listed in the table.

20. The method of claim 13, wherein maintaining the mapping further comprises a system administrator creating the one or more tables and storing the one or more tables in a memory.

21. The method of claim 13, wherein access to the mapping is enabled according to usernames and passwords corresponding to the one or more users.

22. The method of claim 13, wherein the target devices are connected to a non-IP network and wherein the method further comprises interfacing with the non-IP network.

23. The method of claim 13, wherein the non-IP network comprises a SCSI bus.

24. The method of claim 13, wherein enabling access from the users to the one or more target devices comprises directing at least one of the one or more users to backup data to a target device which is identified in a table associated with the at least one user.
